(19) United States
(12) Patent Application Publication
(10) Pub. No.: US 2007/0025474 A1
(43) Pub. Date: Feb. 1, 2007

(54) Receiver IQ imbalance calibration

(75) Inventors: Rajendra T. Moorti, Mountain View, CA (US); Joachim S. Hammerschmidt, Mountain View, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/434,379

(22) Filed: May 15, 2006

Related U.S. Application Data
(60) Provisional application No. 60/704,111, filed on Jul. 29, 2005.

(51) Int. Cl. H04L 27/22

(52) U.S. Cl. 375/329

(57) ABSTRACT

A calibration device for use in a radio receiver enables receiver self-calibration and self-correction of inbound RF signals. The calibration device includes an estimation module for receiving a sample digital packet and calculating imbalance parameters as a function of a portion of the sample digital packet. The calibration device further includes a correction module for applying the imbalance parameters to a received digital packet of an inbound RF signal to produce a corrected digital packet. The received digital packet may be a portion of the sample digital packet, the complete sample digital packet or a new packet.

### CROSS REFERENCE TO RELATED PATENTS

This U.S. application for patent claims the benefit of the filing date of U.S. Provisional Patent Application entitled, “Receiver IQ Imbalance Calibration” (Attorney Docket No. BP4655), having Ser. No. 60/704,111, filed on Jul. 29, 2005, which is incorporated herein by reference for all purposes.

### BACKGROUND OF THE INVENTION

1. Technical Field of the Invention

This invention relates generally to wireless communication systems and in particular to a receiver within such wireless communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into in-phase and quadrature-phase (IQ) baseband signals or intermediate frequency (IF) signals. The filtering stage filters the IQ baseband signals or the IF signals to attenuate unwanted out of band signals to produce filtered signals. The data recovery stage recovers raw data from the filtered signals in accordance with the particular wireless communication standard.

Typically, the transmitter will include one antenna for transmitting the RF signals, which are received by a single antenna, or multiple antennas, of a receiver. When the receiver includes two or more antennas, the receiver will select one of them to receive the incoming RF signals. In this instance, the wireless communication between the transmitter and receiver is a single-input-single-output (SISO) communication, even if the receiver includes multiple antennas that are used as diversity antennas (i.e., selecting one of them to receive the incoming RF signals). For SISO wireless communications, a transceiver includes one transmitter and one receiver. Currently, most wireless local area networks (WLAN) that are IEEE 802.11, 802.11a, 802.11b, or 802.11g employ SISO wireless communications.

Other types of wireless communications include single-input-multiple-output (SIMO), multiple-input-single-output (MISO), and multiple-input-multiple-output (MIMO). In a SIMO wireless communication, a single transmitter processes data into radio frequency signals that are transmitted to a receiver. The receiver includes two or more antennas and two or more receiver paths. Each of the antennas receives the RF signals and provides them to a corresponding receiver path (e.g., LNA, down conversion module, filters, and ADCs). Each of the receiver paths processes the received RF signals to produce digital signals, which are combined and then processed to recapture the transmitted data.

For a multiple-input-single-output (MISO) wireless communication, the transmitter includes two or more transmission paths (e.g., digital to analog converter, filters, up-conversion module, and a power amplifier) that each converts a portion of baseband signals into RF signals, which are transmitted via corresponding antennas to a receiver. The receiver includes a single receiver path that receives the multiple RF signals from the transmitter.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The recaptured streams of data are combined and subsequently processed to recover the original data.

To be backward compatible with legacy devices, a transceiver should be able to facilitate communications in any of the communications types (e.g., SISO, MISO, SIMO, and MIMO). Each communications type prescribes a different operating mode. For example, each operating mode may specify a different channel bandwidth, frequency band, number of transmit/receive paths, data rate, and frame length. As an example, IEEE 802.11 (j) prescribes a 10 MHz channel bandwidth, IEEE 802.11(a) and (g) prescribe a 20 MHz channel for a 2.4 to 2.5 GHz frequency band, and IEEE 802.11(n) is contemplating a channel bandwidth of 20-40 MHz for a 4.9 to 5.850 GHz frequency band.

Regardless of the type of wireless communication, most receivers experience some leakage (i.e., cross-talk) between the in-phase and quadrature-phase components of a received signal due to non-idealities in the down-conversion module. Such leakage produces imbalance between the I and Q components in the received signal. Historically, IQ imbalance has been minimized by calibrating the down-conversion module off-line using an external calibration device (e.g., a spectrum analyzer or oscilloscope) to determine a set of coefficients characterizing the non-idealities in the down-conversion module, and then multiplying the I and Q signals by the set of coefficients to effectively remove the IQ imbalance in the I and Q signals.

However, with the introduction of new types of wireless communications operating modes of the receiver, such as SIMO, MIMO and MISO, calibrating the receiver for each operating mode has become expensive and time-consuming. For each operating mode, either different calibration devices or different settings of the calibration device are used, increasing cost and test time. In addition, calibration of the receiver does not take into account any IQ imbalance produced as a result of non-idealities in the transmitter.

Therefore, a need exists for a receiver that is capable of efficiently calibrating out IQ imbalance in any operating mode at a reduced cost.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a schematic block diagram of a wireless communication system in accordance with the present invention;

FIG. 2 is a schematic block diagram of a wireless communication device in accordance with the present invention;

FIG. 3 is a schematic block diagram of another wireless communication device capable of operating in multiple modes in accordance with the present invention;

FIG. 4 is a schematic block diagram of a radio frequency receiver of the wireless communication device of FIG. 3 including a calibration module in accordance with the present invention;

FIG. 5 is a diagram of a packet calibrated using the calibration module shown in FIG. 4 in accordance with the present invention;

FIG. 6 is a schematic block diagram of an exemplary calibration module in accordance with the present invention;

FIG. 7 is a schematic block diagram of another exemplary calibration module in accordance with the present invention;

FIG. 8 is a schematic block diagram of an exemplary receiver incorporating an exemplary off-line calibration module in accordance with the present invention;

FIG. 9 is a schematic block diagram of an exemplary transceiver incorporating an exemplary real-time calibration module in accordance with the present invention;

FIGS. 10A and 10B are schematic block diagrams of exemplary distributed calibration modules in accordance with the present invention; and

FIG. 11 is a logic diagram of an exemplary process for calibrating a receiver to remove IQ imbalance in an inbound signal in accordance with the present invention.

### DETAILED DESCRIPTION OF THE INVENTION

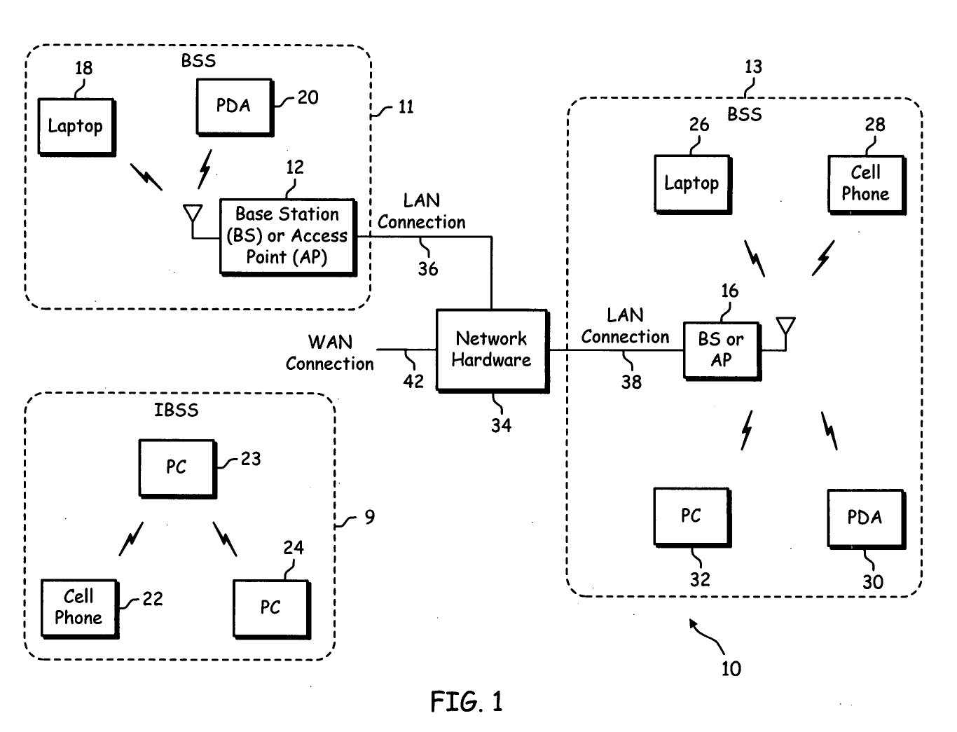

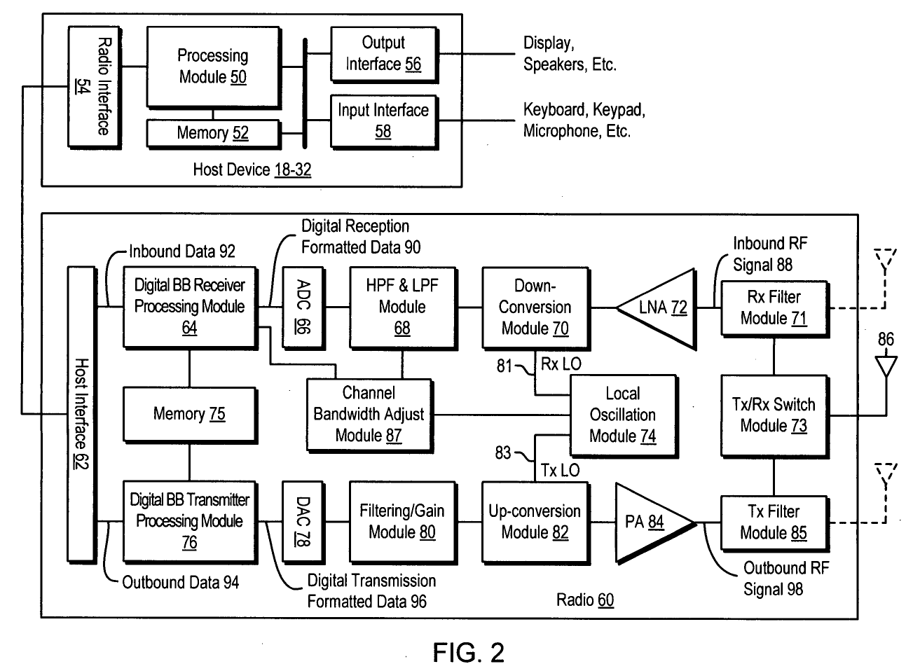

FIG. 1 is a schematic block diagram illustrating a communication system 10 that includes a plurality of base stations and/or access points 12, 16, a plurality of wireless communication devices 18-32 and a network hardware component 34. Note that the network hardware 34, which may be a router, switch, bridge, modem, system controller, et cetera provides a wide area network connection 42 for the communication system 10. Further note that the wireless communication devices 18-32 may be laptop host computers 18 and 26, personal digital assistant hosts 20 and 30, personal computer hosts 24 and 32 and/or cellular telephone hosts 22 and 28. The details of the wireless communication devices will be described in greater detail with reference to FIG. 2.

Wireless communication devices 22, 23, and 24 are located within an independent basic service set (IBSS) area and communicate directly (i.e., point to point). In this configuration, these devices 22, 23, and 24 may only communicate with each other. To communicate with other wireless communication devices within the system 10 or to communicate outside of the system 10, the devices 22, 23, and/or 24 need to affiliate with one of the base stations or access points 12 or 16.

The base stations or access points 12, 16 are located within basic service set (BSS) areas 11 and 13, respectively, and are operably coupled to the network hardware 34 via local area network connections 36, 38. Such a connection provides the base station or access point 12 16 with connectivity to other devices within the system 10 and provides connectivity to other networks via the WAN connection 42. To communicate with the wireless communication devices within its BSS 11 or 13, each of the base stations or access points 12-16 has an associated antenna or antenna array. For instance, base station or access point 12 wirelessly communicates with wireless communication devices 18 and 20 while base station or access point 16 wirelessly communicates with wireless communication devices 26-32. Typically, the wireless communication devices register with a particular base station or access point 12, 16 to receive services from the communication system 10.

Typically, base stations are used for cellular telephone systems and like-type systems, while access points are used for in-home or in-building wireless networks (e.g., IEEE 802.11 and versions thereof, Bluetooth, and/or any other type of radio frequency based network protocol). Regardless of the particular type of communication system, each wireless communication device includes a built-in radio and/or is coupled to a radio.

FIG. 2 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, a radio interface 54, an input interface 58, and an output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, et cetera such that the received data may be displayed. The radio interface 54 also provides data from the processing module 50 to the radio 60. The processing module 50 may receive the outbound data from an input device such as a keyboard, keypad, microphone, et cetera via the input interface 58 or generate the data itself. For data received via the input interface 58, the processing module 50 may perform a corresponding host function on the data and/or route it to the radio 60 via the radio interface 54.

Radio 60 includes a host interface 62, digital receiver processing module 64, an analog-to-digital converter 66, a high pass and low pass filter module 68, an IF mixing down conversion stage 70, a receiver filter 71, a low noise amplifier 72, a transmitter/receiver switch 73, a local oscillation module 74, memory 75, a digital transmitter processing module 76, a digital-to-analog converter 78, a filtering/gain module 80, an IF mixing up conversion stage 82, a power amplifier 84, a transmitter filter module 85, a channel bandwidth adjust module 87, and an antenna 86. The antenna 86 may be a single antenna that is shared by the transmit and receive paths as regulated by the Tx/Rx switch 73, or may include separate antennas for the transmit path and receive path. The antenna implementation will depend on the particular standard to which the wireless communication device is compliant.

The digital receiver processing module 64 and the digital transmitter processing module 76, in combination with operational instructions stored in memory 75, execute digital receiver functions and digital transmitter functions, respectively. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. The digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64 and/or 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The host interface 62 routes the outbound data 94 to the digital transmitter processing module 76, which processes the outbound data 94 in accordance with a particular wireless communication standard (e.g., IEEE 802.11(a), 802.11(b), 802.11(g), 802.11(n), Bluetooth, et cetera) to produce outbound baseband signals 96. The outbound baseband signals 96 will be digital base-band signals (e.g., have a zero IF) or a digital low IF signals, where the low IF typically will be in the frequency range of one hundred kilohertz to a few megahertz.

The digital-to-analog converter 78 converts the outbound baseband signals 96 from the digital domain to the analog domain. The filtering/gain module 80 filters and/or adjusts the gain of the analog signals prior to providing it to the IF mixing stage 82. The IF mixing stage 82 converts the analog baseband or low IF signals into RF signals based on a transmitter local oscillation 83 provided by local oscillation module 74. The power amplifier 84 amplifies the RF signals to produce outbound RF signals 98, which are filtered by the transmitter filter module 85. The antenna 86 transmits the outbound RF signals 98 to a targeted device such as a base station, an access point and/or another wireless communication device.

The radio 60 also receives inbound RF signals 88 via the antenna 86, which were transmitted by a base station, an access point, or another wireless communication device. The antenna 86 provides the inbound RF signals 88 to the receiver filter module 71 via the Tx/Rx switch 73, where the Rx filter 71 bandpass filters the inbound RF signals 88. The Rx filter 71 provides the filtered RF signals to low noise amplifier 72, which amplifies the signals 88 to produce an amplified inbound RF signals. The low noise amplifier 72 provides the amplified inbound RF signals to the IF mixing module 70, which directly converts the amplified inbound RF signals into an inbound low IF signals or baseband signals based on a receiver local oscillation 81 provided by local oscillation module 74. The down conversion module 70 provides the inbound low IF signals or baseband signals to the filtering/gain module 68. The high pass and low pass filter module 68 filters the inbound low IF signals or baseband signals to produce filtered inbound signals.

The analog-to-digital converter 66 converts the filtered inbound signals from the analog domain to the digital domain to produce inbound baseband signals 90, where the inbound baseband signals 90 will be digital base-band signals or digital low IF signals, where the low IF typically will be in the frequency range of one hundred kilohertz to a few megahertz. The digital receiver processing module 64, based on settings provided by the channel bandwidth adjust module 87, decodes, descrambles, demaps, and/or demodulates the inbound baseband signals 90 to recapture inbound data 92 in accordance with the particular wireless communication standard being implemented by radio 60. The host interface 62 provides the recaptured inbound data 92 to the host device 18-32 via the radio interface 54.

As one of average skill in the art will appreciate, the wireless communication device of FIG. 2 may be implemented using one or more integrated circuits. For example, the host device may be implemented on one integrated circuit, the digital receiver processing module 64, the digital transmitter processing module 76 and memory 75 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 50 and the digital receiver and transmitter processing module 64 and 76.

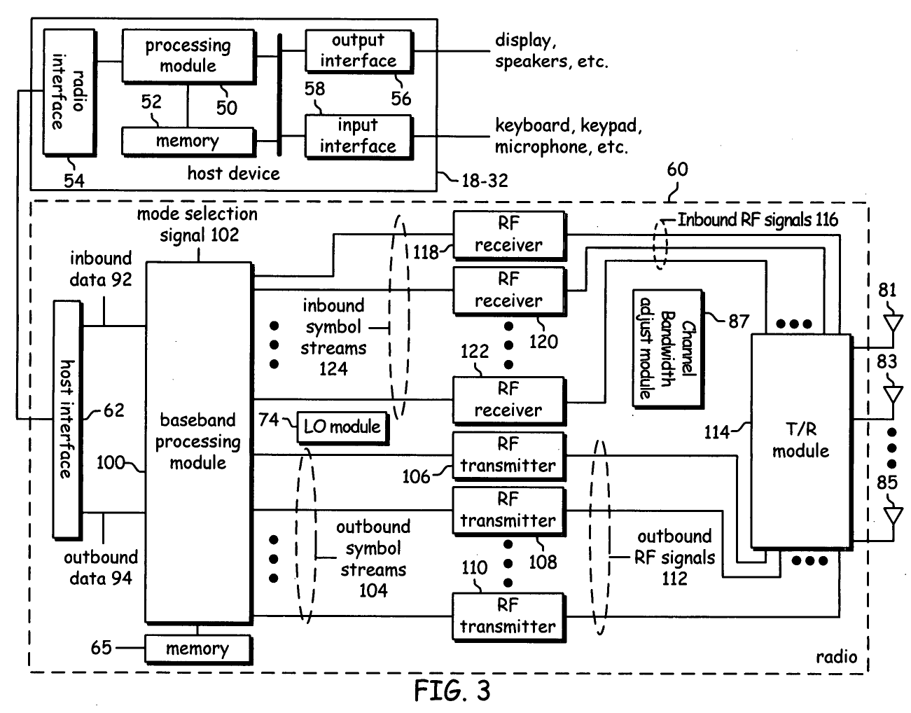

FIG. 3 is a schematic block diagram illustrating a wireless communication device that includes the host device 18-32 and an associated radio 60 capable of operating in multiple operating modes (e.g., SISO, SIMO, MISO and MIMO). For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, et cetera such that the received data may be displayed. The radio interface 54 also provides data from the processing module 50 to the radio 60. The processing module 50 may receive the outbound data from an input device such as a keyboard, keypad, microphone, et cetera via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, a channel bandwidth adjust module 87, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inversc fast Fourier transform, cyclic prefix addition, space and time encoding, and digital baseband to IF conversion. The baseband processing modules 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 64 receives the outbound data 88 and, based on a mode selection signal 102, produces one or more outbound symbol streams 90. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode select signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode select signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode select signal 102 indicates 2, 3 or 4 antennas, the baseband processing module 100 will produce 2, 3 or 4 outbound symbol streams 104 from the outbound data 94.

Depending on the number of outbound streams 104 produced by the baseband module 10, a corresponding number of the RF transmitters 106-110 will be enabled to convert the outbound symbol streams 104 into outbound RF signals 112. In general, each of the RF transmitters 106-110 includes a digital filter and upsampling module, a digital to analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

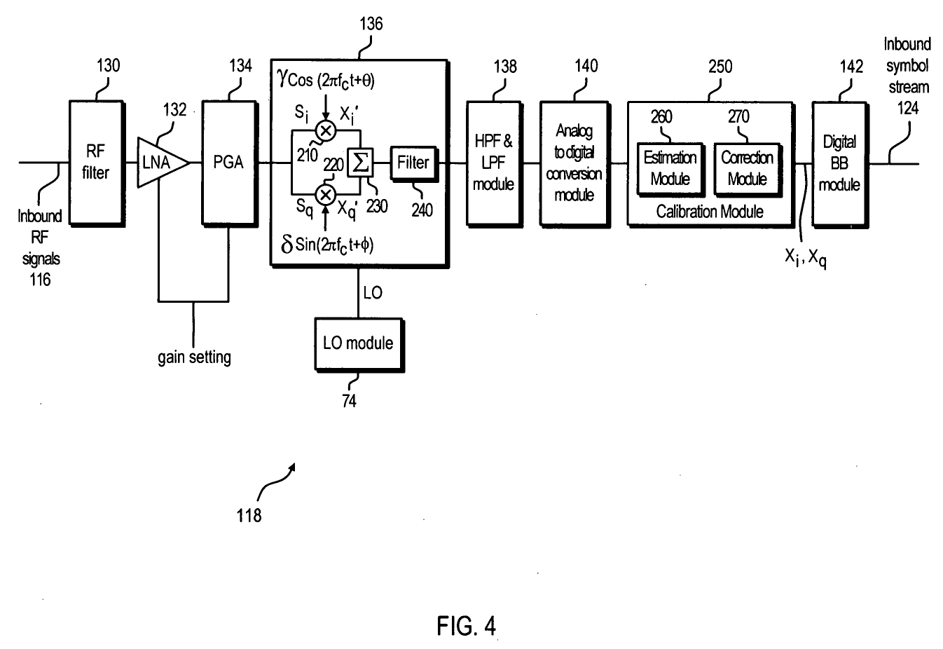

When the radio 60 is in the receive mode, the transmit/receive module 114 receives one or more inbound RF signals 116 via the antennas 81-85 and provides them to one or more RF receivers 118-122, which will be described in greater detail with reference to FIG. 4. The RF receiver 118-122, based on settings provided by the channel bandwidth adjust module 87, converts the inbound RF signals. 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on one integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

FIG. 4 is a schematic block diagram of one of the RF receivers 118. In this embodiment, the RF receiver 118 includes an RF filter 130, a low noise amplifier (LNA) 132, a programmable gain amplifier (PGA) 134, a down-conversion module 136, a high pass and low pass filter module 136, an analog-to-digital conversion module 140, a calibration module 250 and a digital baseband (BB) module 142. The RF filter 130, which may be a high frequency band-pass filter, receives the inbound RF signals 116 and filters them to produce filtered inbound RF signals. The low noise amplifier 132 amplifies the filtered inbound RF signals based on a gain setting and provides the amplified signals to the programmable gain amplifier 134. The programmable gain amplifier 134 further amplifies the inbound RF signals before providing them to the down-conversion module 136.

The down-conversion module 136 includes a pair of mixers 210 and 220 and a filter 240 to mix the inbound in-phase and quadrature-phase RF signals (sᵢ and s_{q}) with a local oscillation (LO) that is provided by the local oscillation module 74 to produce analog in-phase and quadrature-phase (IQ) baseband signals (xᵢ and x_{q}). As shown in FIG. 4, the in-phase local oscillation signal can be represented by γ cos(2πf_{c}+θ), and the quadrature-phase local oscillation signal can be represented by δ sin(2πf_{c}t+Φ). When γ and δ are not equal or θ and Φ are not equal due to non-idealities in the mixers 210 and 220, leakage (i.e., cross-talk) occurs between the in-phase and quadrature-phase components of the baseband signals xᵢ and x_{q}, respectively. Thus, the ideal baseband signals xᵢ and x_{q} can be modeled as a multiple of an IQ compensation matrix and the actual measured imbalanced baseband signals x′ᵢ and x′_{q} as follows:

$$[ \begin{matrix}{x}_{i} \\ {x}_{q}\end{matrix} ] = [ \begin{matrix}1 + b & 0 \\ a & 1\end{matrix} ] [ \begin{matrix}{x}_{i}^{′} \\ {x}_{q}^{′}\end{matrix} ] \qquad ( Equation 1 )$$

The imbalance parameters (a and b) characterize the non-idealities in the mixers 210 and 220. The high pass and low pass filter module 138 filters the analog IQ baseband signals (x′ᵢ and x′_{q}) and provides them to the analog-to-digital conversion module 140 which converts them into digital signals.

The calibration module 250 receives the digitized versions of the filtered analog IQ baseband signals x′ᵢ and x′_{q}, and calibrates the receiver using the imbalanced digital signals to remove the IQ imbalance and produce corrected digital signals xᵢ and x_{q}. The calibration module 250 includes an estimation module 260 and a correction module 270. The estimation module 260 estimates or calculates the imbalance parameters (a and b) from the received imbalanced digital signals and inputs the imbalance parameters to the correction module 270. For example, the estimation module 260 can accumulate products of the in-phase and quadrature-phase components x′ᵢ and x′_{q} as follows:

$${A}_{i} = ρ {\sum }_{n = 0}^{{N}_{meas}} {x}_{i}^{′2} \\ {A}_{q} = ρ {\sum }_{n = 0}^{{N}_{meas}} {x}_{q}^{′2} \\ {A}_{iq} = ρ {\sum }_{n = 0}^{{N}_{meas}} {x}_{i}^{′} {x}_{q}^{′} , \qquad ( Equation 2 )$$

where p is an arbitrary scaling factor and Nₘₑₐₛ is the number of measured samples. Assuming that xᵢ and x_{q} are orthogonal to each other and equal in power, the inner products of xᵢ and x_{q} are the same.
<xᵢ,x_{q}>=0
<xᵢ,xᵢ>=<x_{q}, x_{q}> (Equation 3)
Therefore, the parameters a and b are not dependent on the values of the inner products of xᵢ and x_{q}. The correction module 270 uses the imbalance parameters (a and b) and applies the compensation matrix to the imbalanced digital signals to produce the corrected digital signals xᵢ and x_{q}.

The digital baseband module 142 filters and down samples the corrected digital signals and then adjusts the sampling rate to produce the inbound symbol stream 96. The digital baseband module 142 includes a fast Fourier transform (FFT) module that performs time domain to frequency domain conversions of the symbol stream 96. For example, a 64-point FFT can be used for 20 MHz channels and 128-point FFT can be used for 40 MHz channels.

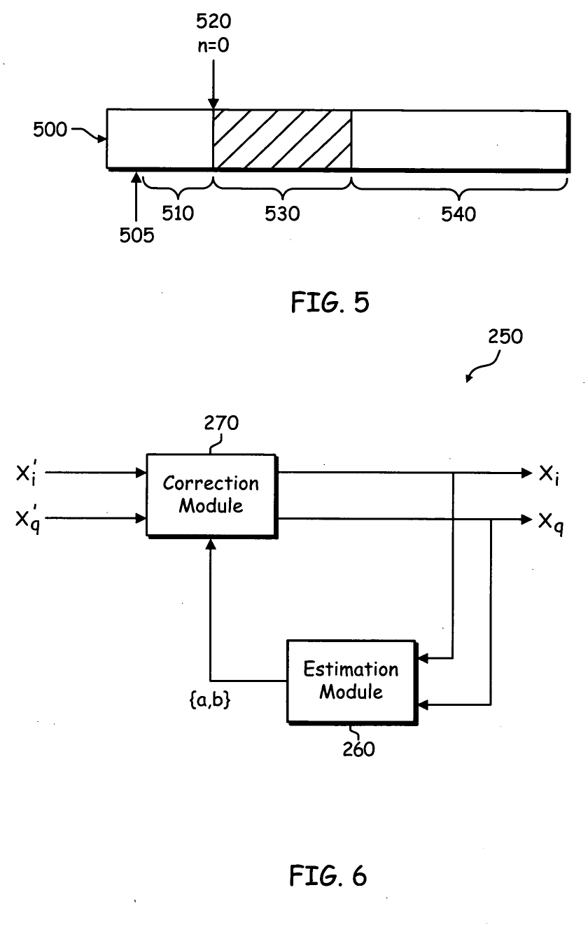

FIG. 5 is a diagram of a packet 500 calibrated using the calibration module shown in FIG. 4 in accordance with the present invention. The packet 500 is an imbalanced digital packet containing in-phase and quadrature-phase signal components x′ᵢ and x′_{q}. The estimation module within the calibration module either detects the receipt of the packet 500 or is forced to detect the receipt of the packet at an initial time 505. After a waiting period 510, the estimation module begins a measurement period 530 at time 520. During the measurement period 530, the estimation module accumulates products of the signal components over a number of samples Nₘₑₐₛ. The measurement period 530 includes a portion of the packet 500 corresponding to a preamble of the packet 500. For example, the measurement period 530 can include one or more of, a short training sequence (STS) segment, a long training sequence (LTS) segment or a signal segment of the preamble of the packet 500.

At the completion of the measurement period 530, the estimation module calculates the imbalance parameters (a and b), which are used by the correction module to correct a packet remainder 540. In one embodiment, the packet remainder 540 includes a remaining portion of the packet 500 after the portion of the packet 500 measured during the measurement period 530. For example, the packet remainder 540 can include one or more of a LTS segment, signal segment and data segment of the packet 500. In another embodiment, the packet remainder 540 represents the complete packet 500, including the portion of the packet 500 measured during the measurement period 530. In still another embodiment, the packet remainder 540 represents a new packet received as part of a new inbound RF signal.

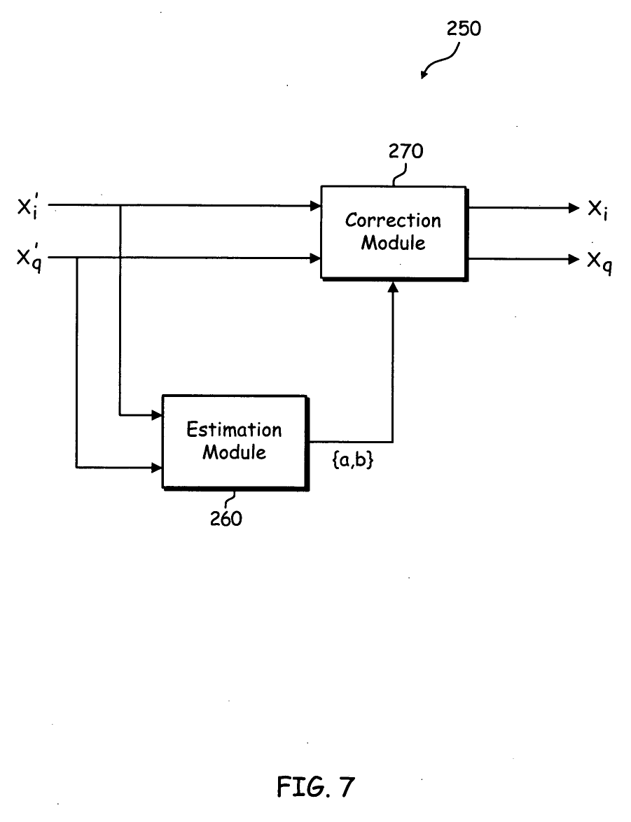

FIG. 6 is a schematic block diagram of an exemplary calibration module 250 in accordance with the present invention. FIG. 6 depicts a feed-back architecture of the calibration module 250. In FIG. 6, the imbalanced digital packet containing in-phase and quadrature-phase signal components x′ᵢ and x′_{q} is received at the correction module 270 and passed to the estimation module 260. The estimation module 260 detects receipt of the packet, and after the waiting period, the estimation module 260 accumulates products of the signal components x′ᵢ and x′_{q} to calculate the imbalance parameters {a,b}. In one embodiment, the estimation module 260 calculates the imbalance parameters using only a portion of the packet corresponding to a short training sequence (STS) segment of the packet.

The imbalance parameters {a,b} is provided to the correction module 270 for use in correcting the remaining portion of the packet corresponding to the LTS segment, signal segment and data segment of the packet. In one embodiment, the correction module 270 uses the imbalance parameters {a,b} to determine an inverse imbalance matrix to apply to the signal components x′ᵢ and x′_{q}. In another embodiment, the inverse imbalance matrix is calculated by the estimation module 260 and input directly to the correction module 270 for substantially simultaneous correction of the remaining portion of the packet. The output of the correction module is (partially) corrected signal components xᵢ and x_{q}.

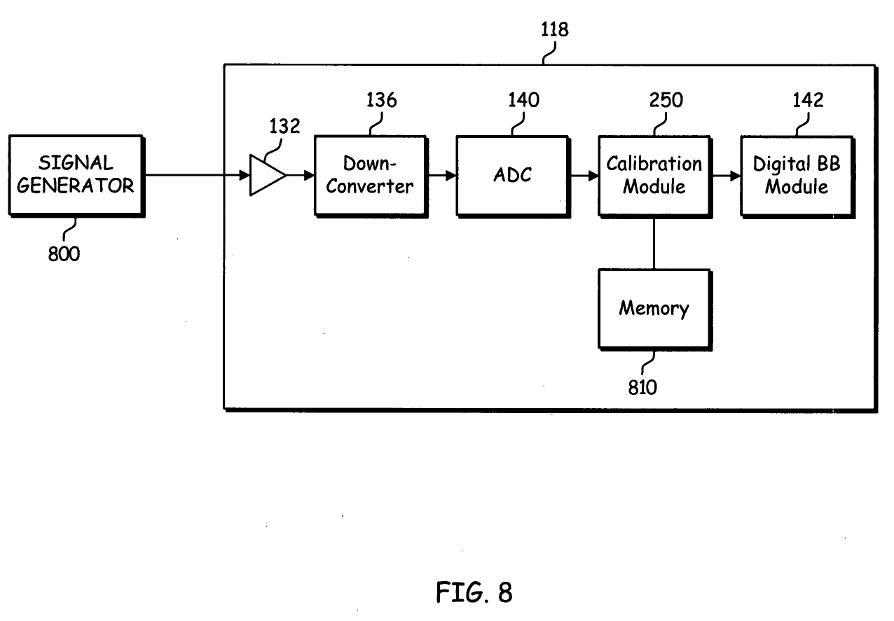

FIG. 7 is a schematic block diagram of another exemplary calibration module in accordance with the present invention. FIG. 7 depicts a feed-forward architecture of the calibration module 250. In FIG. 7, the imbalanced digital packet containing in-phase and quadrature-phase signal components x′ᵢ and x′_{q} is received at the calibration module 250 and input to both the estimation module 260 and the correction module 270. The estimation module 260 detects receipt of the packet, and after the waiting period, the estimation module 260 accumulates products of the signal components x′ᵢ and x′_{q} to calculate the imbalance parameters {a,b}, as described above.

The estimation module 260 provides the imbalance parameters {a,b} to the correction module 270 for use in correcting the signal components x′ᵢ and x′_{q} in the entire packet (e.g., the STS segment, LTS segment, signal segment and data segment of the packet). Thus, the output of the correction module is complete corrected signal components xᵢ and x_{q}.

In FIGS. 6 and 7, the receiver calibration is performed “on-the-fly”, which enables the receiver to compensate for both the IQ imbalance produced as a result of non-linearities in the receiver and the IQ imbalance produced as a result of non-idealities in the transmitter, in addition to any imbalance in the channel. Thus, the feed-back and feed-forward architectures of FIGS. 6 and 7 correct for all IQ imbalances in the signal, regardless of the transmitter or the type of operating mode of the transmitter and/or receiver.

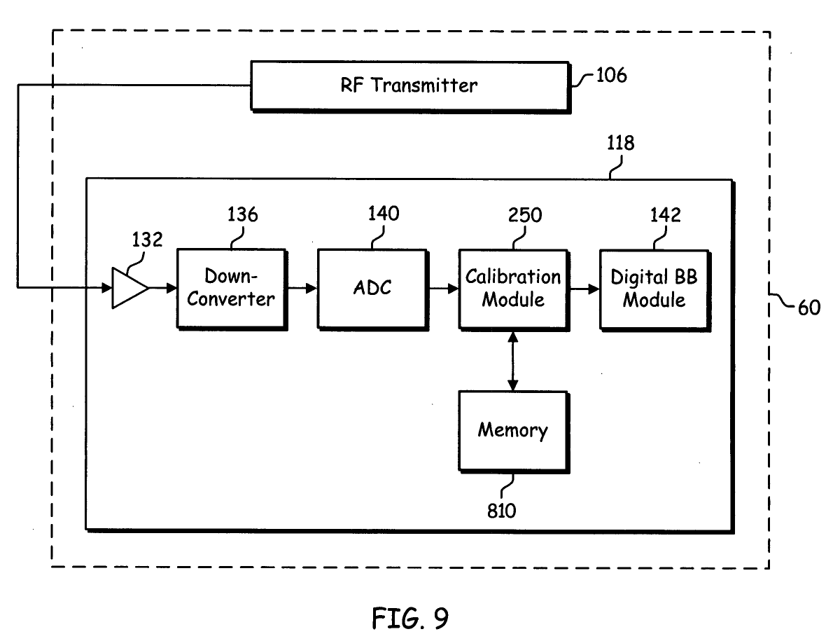

FIG. 8 is a schematic block diagram of an exemplary receiver (e.g., receiver 118) incorporating an exemplary off-line calibration module 250 in accordance with the present invention. A precision signal generator 800 generates a known (ideal) radio frequency (RF) signal and applies the known signal to the receiver 118. The ideal signal is received at the low noise amplifier 132 of the receiver 118 for amplification before being provided to the down-conversion module 136. The down-conversion module 136 mixes the inbound RF signal with a local oscillation (LO) to produce analog in-phase and quadrature-phase (IQ) baseband signals. The analog IQ baseband signals are provided to the analog-to-digital conversion module 140 which converts them into digital signals.

The calibration module 250 receives the digitized versions of the filtered analog IQ baseband signals and calibrates the receiver 118 using the imbalanced digital signals to estimate the imbalance parameters {a,b}. The imbalance parameters {a,b} are stored in a memory 810 for later use by the calibration module 250 to remove the IQ imbalance in subsequently received signals to provide corrected digital signals to the digital baseband module 142, as described above.

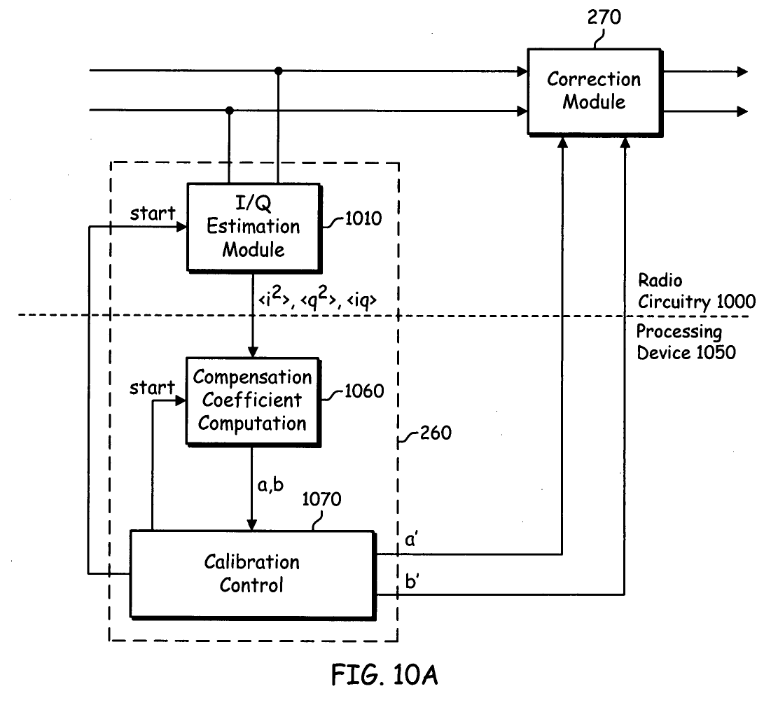

FIG. 9 is a schematic block diagram of an exemplary transceiver incorporating an exemplary off-line calibration module in accordance with the present invention. In FIG. 9, the receiver 118 is shown included in a radio transceiver 60. The radio transceiver 60 includes an RF transmitter (e.g., transmitter 106) and the receiver 118. The transmitter 106 is calibrated using any type of calibration procedure, such that the transmitter 106 effectively produces a known (ideal) radio frequency (RF) signal. An example of a transmitter calibration procedure is described in co-pending U.S. patent application Ser. No. ______ (Attorney Docket Number BU4170), filed on Apr. 4, 2006, which is hereby incorporated by reference in its entirety. The transmitter 106 and receiver 118 are coupled in a loop-back configuration to apply the ideal RF signal generated by the transmitter 106 to the receiver 118. In one embodiment, the loop-back connection is provided within the transceiver 60 itself. In another embodiment, the loop-back connection is provided externally by an external interface, e.g., a loadboard or probecard in package or wafer test.

In a further embodiment, the transmitter 106 and receiver 118 are part of a multi-core RF integrated circuit, in which the transmitter 106 is part of one core transceiver, while the receiver 118 is part of another core transceiver. In this embodiment, the output of a first core transmitter 106 is input to a second core receiver 118. The unused receiver of the first core and the unused transmitter of the second core can be powered down.

The ideal signal from the transmitter 106 is received at the low noise amplifier 132 of the receiver 118 for amplification before being provided to the down-conversion module 136. The down-conversion module 136 mixes the inbound RF signals with a local oscillation (LO) to produce analog in-phase and quadrature-phase (IQ) baseband signals. The analog IQ baseband signals are provided to the analog-to-digital conversion module 140 which converts them into digital signals. The calibration module 250 receives the digitized versions of the filtered analog IQ baseband signals and calibrates the receiver 118 using the imbalanced digital signals to estimate the imbalance parameters {a,b}. The imbalance parameters {a,b} are stored in the memory 810 for later use by the calibration module 250 to remove the IQ imbalance in subsequently received signals to provide corrected digital signals to the digital baseband module 142, as described above.

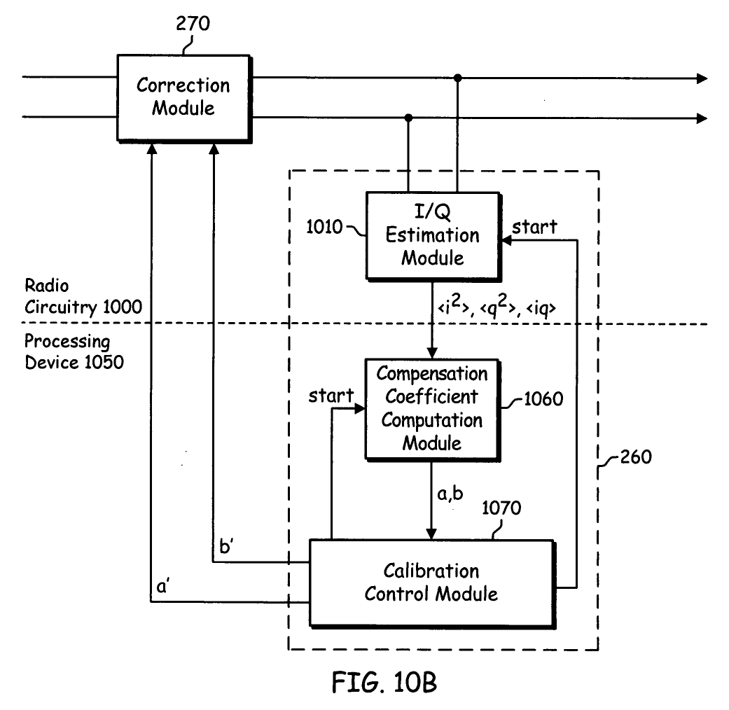

FIGS. 10A and 10B are schematic block diagrams of exemplary distributed calibration modules in accordance with the present invention. In FIGS. 10A and 10B, the estimation module 260 is distributed between radio circuitry 1000 and a processing device 1050. The radio circuitry 1000 includes dedicated hardware for estimating the I/Q parameters, <i²>, <q²>and <iq>and the correction module 270, whereas the processing device 1050 includes software executable to compute the imbalance parameters a, b based on the I/Q parameters, <i²>, <q²>and <iq>. More particularly, the radio circuitry 1000 includes an I/Q estimation module 1010 for estimating the I/Q parameters, while the processing device 1050 includes a compensation coefficient computation module 1060 for calculating the imbalance parameters. The processing device 1050 further includes a calibration control module 1070 for communicating with the I/Q estimation module 1010, the compensation coefficient computation module 1060 and the correction module 270, and for synchronizing the calibration procedure with other system-level tasks.

The radio circuitry 1000 may include a printed circuit board that contains the radio and digital signal processor chips, in addition to other on-board components (e.g., power amplifier, antenna switches, etc.). For example, the radio circuitry 1000 may include the chips and/or circuitry responsible for receiving the inbound RF signals from the antenna, translating the signals from RF to baseband and recovering and decoding the original data sequence in the inbound RF signals. Thus, the radio circuitry 1000 may include the physical transmission layer and parts of the medium access layer that perform functions in hardware. The processing device 1050 may be a microprocessor, micro-controller, digital signal processor, microcomputer, central processing unit, field programmable gate array, programmable logic device, state machine, logic circuitry and/or any device that is capable of executing software to manipulate signals (analog and/or digital) based on operational instructions of the software. For example, the processing device 1050 may include a system driver supporting the communication on various higher protocol layers, such as IP and TCP. In addition, the system driver may contain the software executables for the compensation coefficient computation module 1060 and the calibration control module 1070.

FIG. 10A depicts a distributed feed-forward architecture of the calibration module, while FIG. 10B depicts a distributed feed-back architecture of the calibration module. In FIG. 10A, the imbalanced digital packet containing in-phase and quadrature-phase signal components received at the calibration module is input to both the estimation module 260 and the correction module 270. The estimation module 260 detects receipt of the packet, and after the waiting period, the I/Q estimation module 1010 of the estimation module 260 accumulates products of the signal components, <i²>, <q²>and <iq>, to determine the I/Q parameters. In an exemplary embodiment, the I/Q estimation module 1010 includes a single building block (e.g., multiplier-accumulator) that processes each sample over an integration window.

The I/Q estimation module 1010 further passes the calculated I/Q parameters to the compensation coefficient computation module 1060 to calculate the imbalance parameters {a,b}, as described above. In an exemplary embodiment, the complex computations necessary for calculating the imbalance parameters {a,b} are performed using arithmetic logic units (ALUs) in the processing device 1050.

The calibration control module 1070 of the estimation module 260 provides the calculated imbalance parameters {a,b} to the correction module 270 for use in correcting the signal components in the entire packet (e.g., the STS segment, LTS segment, signal segment and data segment of the packet). In another embodiment, as shown in FIGS. 10A and 10B, the calibration control module 1070 averages imbalance parameters over multiple calibrations and provides average imbalance parameters {a′,b′} to the correction module 270. In a further embodiment, the calibration control module 1070 is capable of comparing the calculated imbalance parameters {a,b} to predicted imbalance parameters to check the validity of the calculated imbalance parameters {a,b}. If the calculated imbalance parameters {a,b} differ from the predicted imbalance parameters by more than a threshold amount, the calibration control module 1070 may not provide the calculated imbalance parameters {a,b} to the correction module 270. This prevents external interference signals from affecting the receiver calibration procedure. The output of the correction module 270 is complete corrected signal components.

In FIG. 10B, the imbalanced digital packet containing in-phase and quadrature-phase signal components is received at the correction module 270 and passed to the I/Q estimation module 1010 of the estimation module 260. The I/Q estimation module 1010 detects receipt of the packet, and after the waiting period, the I/Q estimation module 1010 accumulates products of the signal components, <i²>, <q²>and <iq>, to determine the I/Q parameters and passes the I/Q parameters to the compensation coefficient computation module 1060 to calculate the imbalance parameters {a,b}, as described above. The imbalance parameters {a,b} are provided to the correction module 270 by the calibration control module 1070 for use in correcting any remaining portion of the packet (e.g., the LTS segment, signal segment and data segment of the packet). The output of the correction module 270 is (partially) corrected signal components.

In FIGS. 10A and 10B, the receiver calibration can be performed “on-the-fly”, at periodic intervals or in response to changes detected by the processing device 1050. For example, the processing device 1050 can poll a temperature sensor in the radio circuitry 1000 to detect changes in temperature and initiate the receiver calibration procedure if the temperature change exceeds a threshold amount.

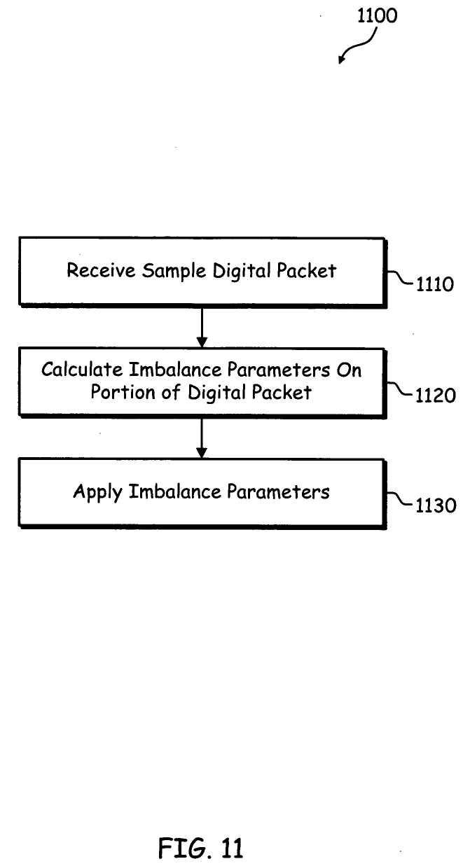

FIG. 11 is a logic diagram of an exemplary process 1100 for calibrating a receiver to remove IQ imbalance in an inbound signal in accordance with the present invention. The processing begins at step 1110 where a sample digital packet is received at a receiver. The sample digital packet is either a part of an inbound RF signal to be corrected or a test signal for use in calibrating the receiver. The process then proceeds to step 1120 where imbalance parameters representing the imbalance between the in-phase and quadrature-phase components of the packet are estimated. For example, the imbalance parameters can be estimated from accumulated products of the in-phase and quadrature-phase components of the packet. Finally, at step 1130, the imbalance parameters are used to determine an inverse imbalance matrix that is applied to a received digital packet to remove the IQ imbalance in the received digital packet. The received digital packet can be a portion of the sample digital packet, the complete sample digital packet or a new digital packet.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

The preceding discussion has presented a receiver capable of calibrating itself to remove IQ imbalance in the receiver. As one of ordinary skill in the art will appreciate, other embodiments may be derived from the teachings of the present invention without deviating from the scope of the claims.

What is claimed is:

1. A calibration device for use in a radio receiver, comprising:
an estimation module operably coupled to receive a sample digital packet and to calculate imbalance parameters as a function of a portion of the sample digital packet; and
a correction module operably coupled to receive a received digital packet of an inbound radio frequency (RF) signal and to apply the imbalance parameters to the received digital packet to produce a corrected digital packet.

2. The calibration device of claim 1, wherein the estimation module is further operable to accumulate products of in-phase and quadrature-phase components of the portion of the sample digital packet to calculate the imbalance parameters.

3. The calibration device of claim 1, wherein the sample digital packet is the received digital packet.

4. The calibration device of claim 3, wherein the correction module is further operable to apply the imbalance parameters to a remaining portion of the sample digital packet to produce the corrected digital packet.

5. The calibration device of claim 3, wherein the correction module is further operable to apply the imbalance parameters to an entire portion of the sample digital packet to produce the corrected digital packet.

6. The calibration device of claim 3, wherein the portion of the sample digital packet includes at least a portion of a short training sequence segment of the sample digital packet.

7. The calibration device of claim 6, wherein the estimation module is further operable to detect the sample digital packet at an initial time and perform measurements of the sample digital packet during a measurement period after a waiting period from the initial time to calculate the imbalance parameters.

8. The calibration device of claim 1, wherein the sample digital packet is part of a known inbound RF signal.

9. The calibration device of claim 8, further comprising:
a memory for storing the imbalance parameters.

10. The calibration device of claim 1, wherein the estimation module is distributed between radio circuitry and a processing device, said radio circuitry including dedicated hardware for calculating products of in-phase and quadrature-phase components of the portion of the sample digital packet, said processing device including software executable to calculate the imbalance parameters as a function of the products of the in-phase and quadrature-phase components of the portion of the sample digital packet.

11. The calibration device of claim 10, wherein the processing device further includes a calibration control module operable to control calibrations of the receiver.

12. A radio receiver, comprising:
a low noise amplifier operably coupled to amplify an inbound radio frequency (RF) signal to produce an amplified inbound RF signal;
a down-conversion module operably coupled to convert the amplified inbound RF signal to a low intermediate frequency (IF) signal;
an analog-to-digital converter operably coupled to convert the low IF signal into a digital low IF signal;
a calibration module operably coupled to receive a sample digital packet from the analog-to-digital converter, calculate imbalance parameters as a function of a portion of the sample digital packet and apply the imbalance parameters to a received digital packet of the digital low IF signal to produce a corrected digital packet; and
a digital demodulator operably coupled to convert the corrected digital packet of the digital low IF signal into inbound digital symbols.

13. The receiver of claim 12, wherein the calibration module is further operable to accumulate products of signal components of the portion of the sample digital packet to calculate the imbalance parameters.

14. The receiver of claim 12, wherein the sample digital packet is the received digital packet.

15. The receiver of claim 14, wherein the calibration module is further operable to apply the imbalance parameters to a remaining portion of the sample digital packet to produce the corrected digital packet.

16. The receiver of claim 14, wherein the calibration module is further operable to apply the imbalance parameters to an entire portion of the sample digital packet to produce the corrected digital packet.

17. The receiver of claim 14, wherein the calibration module is further operable to detect the sample digital packet at an initial time and perform measurements of the sample digital packet during a measurement period after a waiting period from the initial time to calculate the imbalance parameters.

18. The receiver of claim 12, wherein the sample digital packet is part of a known inbound RF signal.

19. The receiver of claim 18, wherein the known inbound RF signal is produced by a transmitter of a transceiver incorporating the receiver.

20. The receiver of claim 18, wherein the known inbound RF signal is produced by a transmitter in the same device as the receiver.

21. A method for calibrating a receiver to remove imbalance between in-phase and quadrature-phase components of an inbound radio frequency (RF) signal, the method comprising the steps of:
calculating imbalance parameters as a function of a portion of a sample digital packet received at the receiver; and
applying the imbalance parameters to a received digital packet of the inbound RF signal to produce a corrected digital packet

22. The method of claim 21, wherein the step of calculating further comprises the step of:
accumulating products of in-phase and quadrature-phase components of the portion of the sample digital packet to calculate the imbalance parameters.

23. The method of claim 21, wherein the sample digital packet is the received digital packet, and wherein the step of applying further comprises the step of:
applying the imbalance parameters to a remaining portion of the sample digital packet to produce the corrected digital packet.

24. The method of claim 21, wherein the sample digital packet is the received digital packet, and wherein the step of applying further comprises the step of:
applying the imbalance parameters to an entire portion of the sample digital packet to produce the corrected digital packet.

25. The method of claim 21, wherein the step of calculating further comprises the steps of:
detecting the sample digital packet at an initial time; and
performing measurements of the sample digital packet during a measurement period after a waiting period from the initial time to calculate the imbalance parameters.

26. The method of claim 21, wherein the sample digital packet is part of a known inbound RF signal, and further comprising the step of:
storing the imbalance parameters.
